(19) United States
(12) Patent Application Publication
(10) Pub. No.: US 2012/0117836 A1
(43) Pub. Date: May 17, 2012

(54) Short-Term Memory Aid Book with Sight, Sound and Scent

(76) Inventors: Joanne Preneveau, Salem, NH (US); Paul Coutsonikas, Lawrence, MA (US)

(21) Appl. No.: 13/151,328

(22) Filed: Jun. 2, 2011

Related U.S. Application Data
(60) Provisional application No. 61/414,596, filed on Nov. 17, 2010.

(51) Int. Cl. G09F 27/00

(52) U.S. Cl. 40/455

(57) ABSTRACT

A photo album kit specifically tailored to assist friends and loved ones in helping those suffering from short-term memory loss. The device allows a friend or loved one to collect photographs, audio, scents and textures for review with the affected individual. The device includes an audio playback means, allowing specific audio to be played with a given picture or page. Further, the device includes a means for affixing scented fabrics and textures to allow the patient exposure to familiar smells and feelings in order to rekindle a memory. The kit may have pages specifically formatted for genealogy or bibliographies, to assist the patient's recollection of the names and relations of loved ones. The present invention also includes a method of using an album with photos, sounds and scents to facilitate the recovery of those with short-term memory loss.

### CROSS REFERENCE TO RELATED APPLICATION

This application claims the benefit of U.S. Provisional Application No. 61/414,596 filed on Nov. 17, 2010 entitled “Life Book Kit with Sound and Scent.”

### BACKGROUND OF THE INVENTION

1. Field of the Invention

The present invention relates to a book kit equipped with sound and scent, along with a method of exposure that is designed to facilitate memory recovery in individuals suffering from short-term memory loss.

The practice of maintaining scrapbooks or albums for keepsakes such as letters, clippings and photographs is widely practiced. Many individuals maintain an album in which objects are retained because of their personal value and the memories they recall when reviewing its contents after an elapse time.

Very often albums are maintained to include a collection of photographs having particular sentimental value to the owner of the album. Upon reviewing an album, memories of persons, events or places shown in the album are refreshed. The enjoyment and reminiscence derived from the album can often be enhanced by simultaneously hearing a musical composition, song or spoken message, or by smelling a familiar scent that has particular relevance to all or some of the memorabilia retained within the album. Memories are inherently related to an individual's senses, particularly audio and olfactory senses. Recollection of past memories is known to be tied to familiar scents and sounds, which can be stored in memorabilia such as photo albums, keepsakes and scrap books.

At the present time, many photographs are stored in boxes, containers and the like. Some photographs are placed in photo albums. There are many examples of containers and albums used to store photographs. One problem with the storage of photographs is the proper identification of such photographs. Nearly everyone has come across a photograph and wondered who the people in the photograph are, and where and when the photograph was taken. This is particularly likely with individuals suffering from medical conditions affecting short and long memory.

Some containers and albums presently available have space for individuals to write details about a photograph. This can be in the form of cards or spaces on an album leaf. Some also write on the photographs themselves. However, such methods are not ideal. Sights, sounds, smells and textures are ideal for assisting those with memory issues and for aids for recollection of a specific time or person. Additionally, the current containers and album storage procedures have several drawbacks. For example, many areas designated for such information are simply not large enough to describe the memories associated with a particular photograph. Still further, once information is written into the area provided, it may be difficult, if not impossible, to later change or update that information. Also, if information is written directly onto a photograph, there is a chance that the photograph will be damaged.

Yet another drawback to presently available methods of providing identifying information for photographs is that they are not interactive. That is, it is difficult for a later viewer to add information to the information presented for a particular photograph. Still further, if a person is unable to write or recall information relating to the photo, it is difficult to add information to the photograph description. This is common if the subject of the photograph is of an advanced age and one with memory related conditions such as dementia or Alzheimer's disease. It is critical for those with short-term memory deficiencies to be able to record and supplement information during lucid periods.

Still further, it is nearly impossible to add the dimension of another sense to a photograph. This drawback is explained by the inability of a photograph, which is strictly a 2-dimensional visible item, to convey a sense of sound, smell or touch associated with a scene. This can be understood by considering a photograph of a loved one. This photograph would have much more meaning if the loved one's voice could be captured with the photograph. A photograph, by itself, cannot do this. Thus, if someone were taking a picture of children for a grandparent, it would be very helpful for the memory elucidating quality of the photographs if the children's voices could also be heard for each photograph. Presently available photo albums cannot fully fulfill this need. Even beyond the use of photographs for pure enjoyment, using photographs to stimulate memories can benefit greatly by the addition of audio, scent and textural descriptions. Written descriptions simply cannot fully convey the memory in a manner similar to this combination of media.

Individuals who suffer from short-term memory loss may require consistent and frequent reminders of information in order to achieve successful long-term memory retention. Friends and family members may visit often, but afflicted patients can easily forget the identities of their visitors. This can be very confusing, frustrating and upsetting, and may not allow adequate recovery of a person's memory for a particular event or person. An effective solution is necessary. The present invention provides a device and associated method that assists individuals afflicted with short-term memory loss in recovery.

2. Description of the Prior Art

There exists in the prior art several variations on the traditional photo album, involving the addition of spaces to add descriptions or audio annotations. However, these prior art devices have several known drawbacks, and do not address the needs of patients suffering from short-term memory loss conditions.

LeVeau U.S. Pat. No. 4,434,567 is directed to a repository for memorabilia that affords visual and auditory sensations. The LeVeau invention includes an integrated music box to provide audio. Similarly, Skidmore U.S. Pat. No. 5,277,452 is directed toward a photo and memorabilia album that includes an audio tape player. The invention contemplates a holder mounted on a cover of the photo album that is configured to retain an audio tape player. The holder includes openings for the speaker and for the tape access door of the tape player. In addition, a second holder mounted on the photo album cover can be provided for removably supporting an audio tape for use with a tape player. The LeVeau and Skidmore inventions make limited use of audio technology. Employing a fixed music box or a cumbersome audio tape, does not allow playing of audio based upon the specific picture. Further, it does not allow the reader to tailor the experience to the needs of the patient. Such tailoring could include replaying certain pictures or changing the order or audio associated with certain photographs. Such changes would not be possible with an audio method such as a tape; in order to make such a change the tape would have to be painstakingly re-recorded.

Other patents provide more sophisticated audio technologies directed toward supplementing photos in an album. Manico U.S. Pat. No. 5,520,544 is directed to a picture or photo album that provides an audio module for recording, storing and playing back audio messages associated with the pictures contained thereby. The audio module responds to predetermined control signals indicating that the album has been opened to a particular page to automatically play back a prerecorded message associated with the information displayed on that page. Such control signals are produced by different combinations of output signals provided by a plurality of photo detectors mounted in the album cover. According to a preferred embodiment, user-activated photo detector pairs are disposed at spaced locations in the album cover to provide the user with a means for indicating to an audio control system which of a plurality of different pictures on the same page calls for the playback of an audio message.

Similarly, Garrett U.S. Pat. No. 6,591,526 is directed to a photo album that includes a computer processing unit (CPU) that records audio, along with control buttons located adjacent to each photograph-accommodating pocket on leaves of the photo album. A microphone unit records audio sound bites for each photograph stored in the album and a control button is pressed to activate a playback circuit, which includes a speaker on the album, to play back the audio recorded for the selected photograph.

While the inventions in the Manico and Garrett patents provide for photo albums with audio features, they do not address the specific need for an album to supplement individuals with short-term memories. The features described in the prior art are adequate to supplement the enjoyment a standard photo album user feels upon viewing, but are not sufficiently stimulating to be optimal for the recovery of those suffering from memory loss.

### SUMMARY OF THE INVENTION

In view of the foregoing disadvantages inherent in the known types of photo albums and memory books now present in the prior art, the present invention provides a new memory aiding photo book wherein the same can be utilized for providing convenience for the user when suffers from conditions resulting in short term memory loss.

The present invention is equipped with sight, sound and scent aids designed to facilitate memory recovery in individuals suffering from short-term memory loss. Primarily, the present invention features a scrapbook for assembly by the patient's family, containing photographs with labels, pages of genealogy, and items containing familiar scents. Further included with the book can be a digital recording device, allowing patients' families to record their voices and other sounds that the patients may recognize to stimulate memory. Additionally, there can be included a means to play a specific sound in association with a specific photograph or page. The present invention appeals to multiple senses for successful generation and elucidation of lost or buried memories.

It is therefore an object of this invention to provide a repository for memorabilia that affords visual, auditory and olfactory sensations. It is a further object of the present invention to use said sensations to assist in the memory rehabilitation of patients suffering from short-term memory loss.

It is another object of this invention to provide an album such as a photo album having associated therewith a musical device, which becomes operative when the album cover is opened. Further, the audio device should be triggered when certain pages or photographs are accessed to play corresponding recorded audio.

It is another object of this invention to provide a keepsake photo album having associated therewith scented fabrics or papers, to assist those suffering short-term memory loss in remembering people and events. It is a further object of this invention to provide a method by which friends and loved ones can facilitate recovery from short-term memory loss using photos, sounds and scents.

Other objects, features and advantages of the present invention will become apparent from the following detailed description taken in conjunction with the accompanying drawings.

### DETAILED DESCRIPTION OF THE INVENTION

The present invention is designed to be used by the friends and loved ones of those suffering from short-term memory loss afflictions. As such, friends and loved ones should prepare the present invention for use, and further review it with the intended user to assist in the recovery of memories.

The present invention provides individuals with an effective and consistent method for helping to recover memories in individuals suffering from short-term memory loss. The present invention may comprise a scrapbook containing labeled photographs; items containing familiar scents, pages of genealogy; and other forms of memorabilia. In use a friend or loved one of an individual afflicted with short-term memory loss will fill the present invention with photographs of family and other important people, objects and events. Further, audio associated with each of the photographs or the book as a whole may be recorded by the loved ones. Such audio will be activated based on the page and photograph being viewed. Such activation may be through a sensor, such as a light sensor, or through buttons corresponding to each page or photo. Such recording is achieved through an onboard circuit or computer system in conjunction with a recording means. Alternatively, audio can be recorded on a user's personal computer and transferred to the present invention via USB or another appropriate transfer method.

The present invention may have a hardbound exterior, allowing for photos or memorabilia to be affixed to the outside cover. The outer cover may come in a variety of color schemes and decorative themes. Friends and loved ones should pick the design of the outer cover most likely to assist their patient in recalling. Such themes could be based on hobbies, activities or other events of the patient's life. Further, the pages are bound using a three-ring binder format or another binding format that allows the individual personalizing the book to add pages or items as needed.

The photographs can display images of a patient's parents, children, extended family members, friends, and pets. Additionally, the present invention can include labels of who is in each picture. The photographs may also include corresponding recordings that may play as the patient views each picture. The present invention can include pages dedicated to genealogy and a number of pages dedicated to biographies of family and friends. Pages can be devoted to individuals or groups of family members and friends. Items to enhance memory recall, such as scented fabrics or papers containing scents that may be familiar to a patient may be included as well. Such fabrics or papers may have metal grommets or other attachment means that allow them to attach to the binding rings of the book. Further, the users may attach other fabrics or textures that may be familiar to the patient to the album pages. The cover or pages of the present invention may also be embellished with colors and images representing the patient's favorite activities, hobbies, music, etc.

The present invention is intended particularly for uses in which short-term memory must be enhanced, rather than simple a simple keep sake. As such, pages will be more likely to focus toward family trees, genealogy and the names and messages of those pictured. The present invention is intended to be assembled by the patient's loved ones, who may review the book frequently and consistently with the patient for best results.

Further, the present invention also includes a method by which may be used to facilitate recovery of short-term memories. Friends and loved ones use repeated exposure to the photos, sounds and scents in the photo kit to assist in recovery. A timely regiment will need to be imposed to effectively assist in recovery. As such, the patient should be shown the book weekly, daily, or even more frequently.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A kit comprising:
a binder designed for retaining photo album pages, said album pages being adapted to support one or more photographs or memory inducing objects;
an attached audio playback means, capable of playing distinct audio selections based upon the photograph location or the album page selected;
a means of recording or transferring audio to said playback means;
said binder having a binding means allowing additional pages or memory inducing objects to be added at locations throughout said binder selected by the user;
and a customizable outer cover.

2) The kit of claim 1, further comprising one or more pieces of fabric affixed with means for attachment to the binding means of said binder;
and said pieces of fabric being infusible with familiar scents.

3) The kit of claim 1, further comprising album pages specifically formatted for genealogy.

4) A method comprising;
creation of a photo album binder with photos as well as associated sounds and scents;
adding biographical and genealogical information to said photo album binder;
exposing a patient suffering from memory loss to said binder;
and repeating exposure to facilitate memory recovery.
